(19) United States
(12) Patent Application Publication
(10) Pub. No.: US 2013/0164122 A1
(43) Pub. Date: Jun. 27, 2013

(54) FASTENER AND FAN ASSEMBLY USING THE SAME

(71) Applicants: JUN-HUI WANG, Shenzhen City (CN); AI-LING HE, Shenzhen City (CN); KUN LI, Shenzhen City (CN)

(72) Inventors: JUN-HUI WANG, Shenzhen City (CN); AI-LING HE, Shenzhen City (CN); KUN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/370,326

(22) Filed: Feb. 10, 2012

(30) Foreign Application Priority Data
Dec. 27, 2011 (CN) 201110444416.9

(51) Int. Cl. F04D 23/00; F16B 41/00

(52) U.S. Cl. 415/182.1; 411/337

(57) ABSTRACT

A fan assembly includes a fan including a board defining a number of through hole, a dustproof member attached to an outer surface of the board, and a number of fasteners. The dustproof member defines a number of fixing legs. Each fastener includes a head abutted against a corresponding one of the fixing legs such that the corresponding leg is sandwiched by the head and the outer surface of the board, a pole extending from a side surface of the head to extend into a corresponding one of the holes, a hook extending in the same direction as the pole from an edge of the head, a projection extending toward the pole from a distal end of the hook and engaged with an inner surface of the board opposite to the outer surface.

### BACKGROUND

1. Technical Field

The present disclosure relates to a fan with a fastener.

2. Description of Related Art

In an electronic device with a fan, such as a computer, a dustproof member is often mounted to the fan by a plurality of screws, which makes it difficult and time-consuming to disengage the dustproof member from the fan.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a fan assembly with a plurality of fasteners.

FIG. 2 is an enlarged view of one of the fasteners of FIG. 1, but viewed from another perspective.

FIG. 3 is an enlarged view of the circled portion III of FIG. 1, but viewed from a different perspective.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

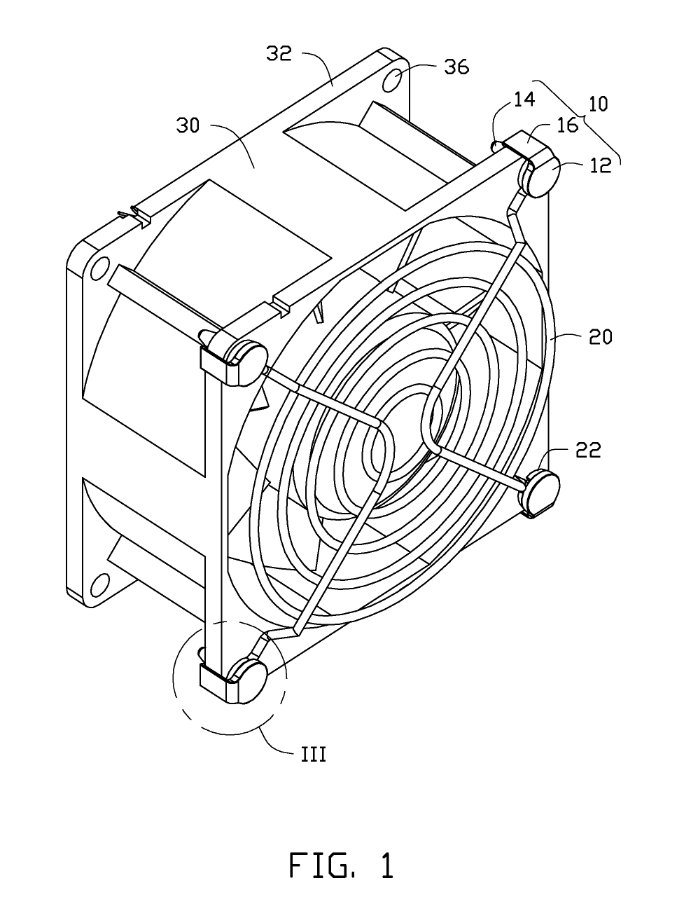

Referring to FIG. 1, an exemplary embodiment of a fan assembly includes a fan 30, a dustproof member 20, and a plurality of fasteners 10.

The fan 30 includes two spaced boards 32. Each board 32 defines four corner holes 36.

The dustproof member 20 is round and includes four fixing legs 22 extending from edges of the dustproof member 20. Each fixing leg 22 defines a through hole (not shown).

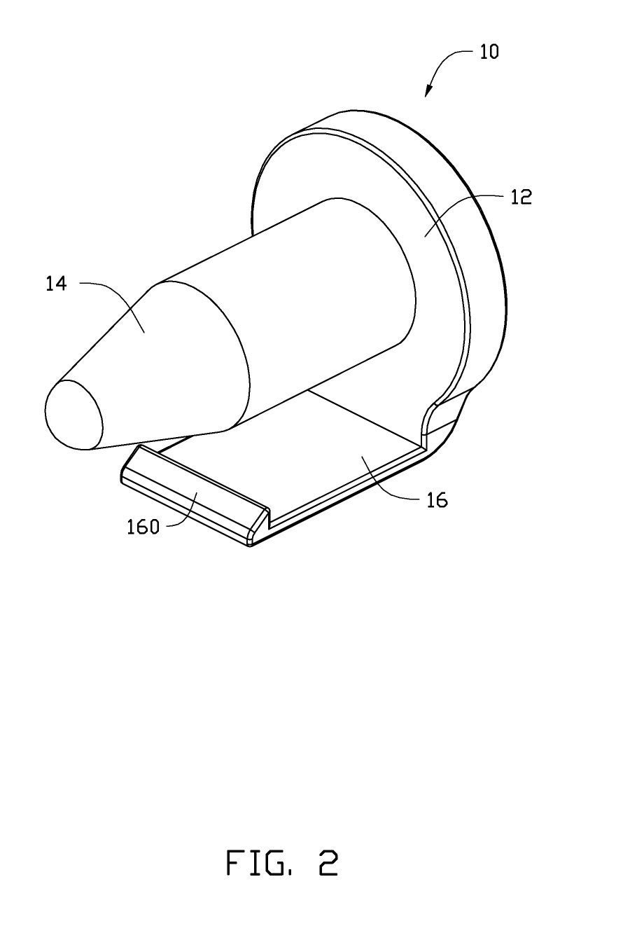

Referring to FIG. 2, each fastener 10 includes a disk-shaped head 12, a pole 14 perpendicularly extending out from a side surface of the head 12, and a hook 16 perpendicularly extending out from an edge of the head 12. A wedge-shaped projection 160 protrudes toward the pole 14 from a distal end of the hook 16.

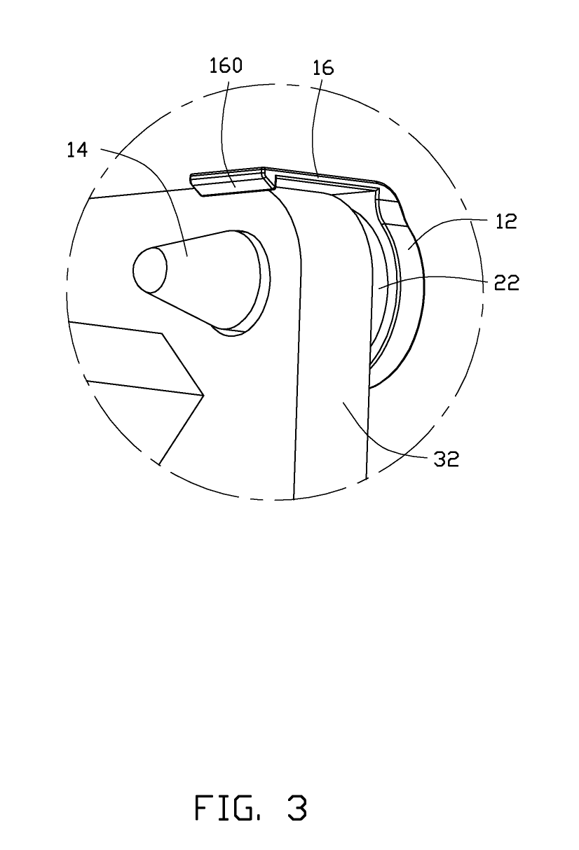

Referring to FIGS. 1 and 3, in assembly, the dustproof member 20 is abutted against an outer surface of one of the boards 32. Each pole 14 is extended through a corresponding one of the through holes of the dustproof member 20 and a corresponding corner hole 36. The hooks 16 are deformed away from the corresponding pole 14, until the projections 160 are engaged with an inner surface of the board 32 opposite to the dustproof member 20. The heads 12 are abutted against an outer surface of the corresponding fixing legs 22, to firmly sandwich the fixing legs 22 with the board 32.

In uninstalling the dustproof member 20, each hook 16 is deformed away from the corresponding pole 14, to disengage the projection 160 from the board 32. Therefore, the dustproof member 20 is ready to be removed from the fan 30.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fastener, comprising:
a head;
a pole extending out from a side surface of the head; and
a hook extending out from an edge of the head, a projection extending toward the pole from a distal end of the hook opposite to the head.

2. The fastener of claim 1, wherein the pole perpendicularly extending out from the side surface of the head; and the hook perpendicularly extending out from the edge of the head.

3. A fan assembly, comprising:
a fan comprising a board defining a plurality of holes;
a dustproof member attached to an outer surface of the board, the dustproof member comprising a plurality of fixing legs; and
a plurality of fasteners each comprising a head abutted against a corresponding one of the fixing legs such that the corresponding leg is sandwiched by the head and the outer surface of the board, a pole extending from a side surface of the head to extend into a corresponding one of the holes, and a hook extending in the same direction as the pole from an edge of the head, a projection extending toward the pole from a distal end of the hook and engaged with an inner surface of the board opposite to the outer surface.
